(19) United States
(12) Patent Application Publication
(10) Pub. No.: US 2026/0124645 A1
(43) Pub. Date: May 7, 2026

(54) DISPOSITIF DE COLLECTE DE PARTICULES SOLIDES CONTENUES DANS UNE SOUPE DE MATIRES ORGANIQUES

(71) Applicant: GREEN CREATIVE, SUCY EN BRIE (FR)

(72) Inventor: Rémi GOMEZ, PARIS (FR)

(21) Appl. No.: 19/119,080

(22) PCT Filed: Oct. 10, 2023
(86) PCT No.: PCT/EP2023/078071

§ 371 Date: Apr. 7, 2025

(30) Foreign Application Priority Data
Oct. 6, 2022 (FR) FR2210268

(51) Int. Cl. B07B 1/24

(52) U.S. Cl. CPC B07B 1/24

(57) ABSTRACT

A device for collecting solid particles contained in an soup of organic matter includes a trommel provided with openings to form a screen that retains solid particles and allows organic matter to pass through; a rotary brush mounted in the trommel for brushing an inner surface of said trommel; motorised means arranged to drive the trommel and the brush in rotation; a rolling cylinder mounted in the trommel and arranged so that an outer surface of the rolling cylinder bears against the inner surface of the trommel so as to force the organic matter to pass through the openings in the trommel.

The present invention relates to the treatment of waste, in particular for the purpose of recycling or disposal thereof, and more particularly to a device for collecting solid particles contained in an soup of organic matter. The term “organic matter” is used herein to mean all bio-waste contained in packaging, in particular waste resulting from the food sector.

### BACKGROUND OF THE INVENTION

In the field of waste treatment, in particular the treatment of waste from mass retail, a friction treatment device is generally used to collect the organic matter adhering to surfaces of packaging to be treated. Such a treatment device makes it possible to separate the bio-waste from its container and to transform it into a bioresource in the form of a soup which is intended to be upgraded as compost (organic fertiliser, used to provide nutrients to the soil) or as digestate (by-product of methanisation, used to directly provide nutrients to plants).

However, the soup obtained at the outlet of the treatment device contains plastic particles (or packaging residues) which have to be collected so that they do not end up in the soil.

It is known for this purpose to use a screw-based phase separator to separate the plastic particles from the bio-waste forming the soup.

While a separator of this kind makes it possible to obtain a soup of satisfactory quality that complies with standards and is compatible with biogas facilities and with being returned to the soil, the plastic particles are nevertheless associated with a quantity of organic matter that is not compatible with plastic incinerators.

### OBJECT OF THE INVENTION

The aim of the invention is therefore to propose a device for collecting solid particles contained in an soup of organic matter that makes it possible to limit the amount of organic matter present on the solid particles collected.

### SUMMARY OF THE INVENTION

To this end, the invention proposes a device for collecting solid particles contained in an soup of organic matter, the device comprising:
a trommel provided with openings to form a screen that retains solid particles and allows organic matter to pass through;
a rotary brush mounted in the trommel for brushing an inner surface of said trommel;
motorised means arranged to drive the trommel and the brush in rotation;
a rolling cylinder mounted in the trommel and arranged so that an outer surface of the rolling cylinder bears against the inner surface of the trommel so as to force the organic matter to pass through the openings in the trommel.

The rolling cylinder serves to guide the solid particles into a space that becomes gradually smaller as the solid particles approach the inner surface of the trommel. This ensures compression of the solid particles against the inner surface of the trommel and therefore the removal of a quantity of organic matter adhering to the solid particles. The rolled solid particles are then caught by the brush and repeatedly subjected to intense brushing, during which they lose an additional amount of organic matter. There is then no, or very little, organic matter remaining on said solid particles.

According to a particular feature of the invention, the brush extends along an axis parallel to a longitudinal axis of the trommel.

According to another particular feature of the invention, the rolling cylinder extends along an axis parallel to a longitudinal axis of the trommel.

According to another particular feature of the invention, the device comprises unclogging means arranged to at least partially unblock the openings in the trommel during the rotation of said trommel.

The unclogging means particularly comprise an unclogging roller provided with teeth which are intended to engage at least partially in the openings of the trommel during the rotation of said trommel.

Advantageously, the teeth of the unclogging roller have a height greater than the thickness of the trommel.

Advantageously, the unclogging roller is mounted outside the trommel.

According to another particular feature of the invention, the device comprises means for introducing the soup of organic matter into the trommel, the introduction means comprising a tube having a first end that opens to the outside of the trommel and a second end that opens to the inside of the trommel.

In particular, the first end of the tube is provided with means for connection to a source of a soup of organic matter.

In particular, the second end of the tube is provided with a deflector arranged to direct the soup of organic matter towards the rolling cylinder.

The invention also relates to a method for collecting solid particles contained in an soup of organic matter, comprising introducing the soup of organic matter into the trommel of such a device.

The invention also relates to a packaging treatment plant, comprising a device for collecting the organic matter adhering to the packaging in the form of a soup, and such a device for collecting the solid particles contained in the soup.

### BRIEF DESCRIPTION OF THE DRAWINGS

The invention will be better understood in the light of the following description, which is purely illustrative and non-limiting, and should be read with reference to the accompanying drawings, in which:

FIG. 1 is a perspective view of a device according to a particular embodiment of the invention;

FIG. 2 is a perspective view of the device shown in FIG. 1;

FIG. 3 is a detailed view of elements of the device shown in FIG. 2;

FIG. 4 shows a section of the elements shown in FIG. 3, along a plane perpendicular to a longitudinal axis of said elements;

FIG. 5 is a partial perspective view of the device shown in FIG. 1.

### DETAILED DESCRIPTION OF THE INVENTION

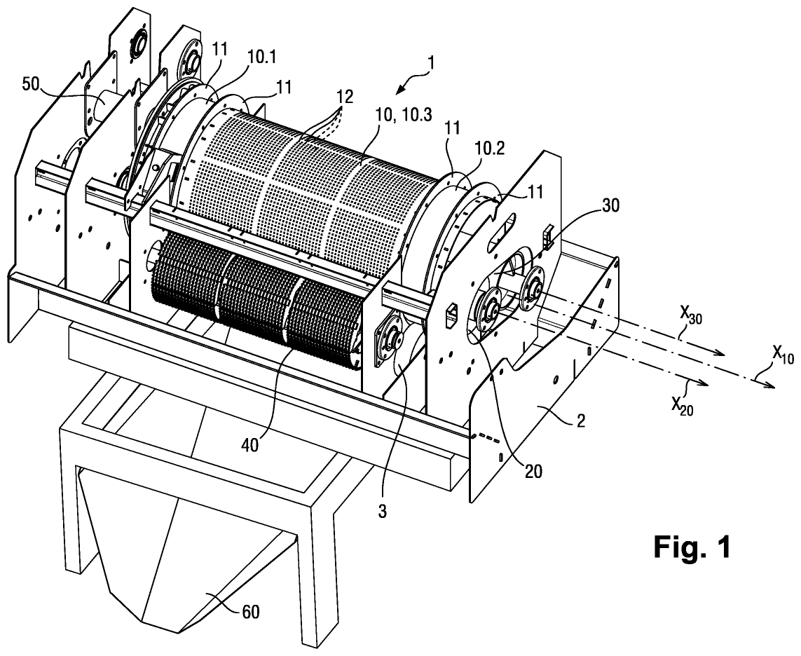

With reference to FIG. 1 and according to a particular embodiment of the invention, a device according to a particular embodiment of the invention, given the overall reference 1, comprises a frame 2 in the form of a structure formed by mechanically welded steel sections, and having a housing which is not shown here for reasons of clarity.

The housing contains a trommel 10 in the form of a rotary drum extending along a longitudinal axis X₁₀. Here, the trommel 10 has a diameter substantially equal to five hundred millimetres and a thickness e substantially equal to four millimetres.

The trommel 10 comprises a first end portion 10.1, a second end portion 10.2, and a central portion 10.3 extending between the first end portion 10.1 and the second end portion 10.2. The first end portion 10.1 and the second end portion 10.2 each comprise two substantially identical outer collars 11 to define two tracks for guiding the trommel 10 in rotation about the axis X₁₀. The free ends of the first end portion 10.1 and of the second end portion 10.2 are closed and open, respectively.

The trommel 10 is driven in rotation about the axis X₁₀ by means of a first motor (not shown) supported by the frame 2. The first end portion 10.1 and the second end portion 10 of the trommel 10 are each guided in rotation by two rollers 3 which are mounted so as to rotate freely about an axis substantially parallel to the axis X₁₀. The rollers 3 extend between the collars 11 of the corresponding end portion 10.1, 10.2.

The central portion 10.3 of the trommel 10 is perforated with a plurality of identical openings 12 distributed symmetrically about the axis X₁₀ so as to form a screen.

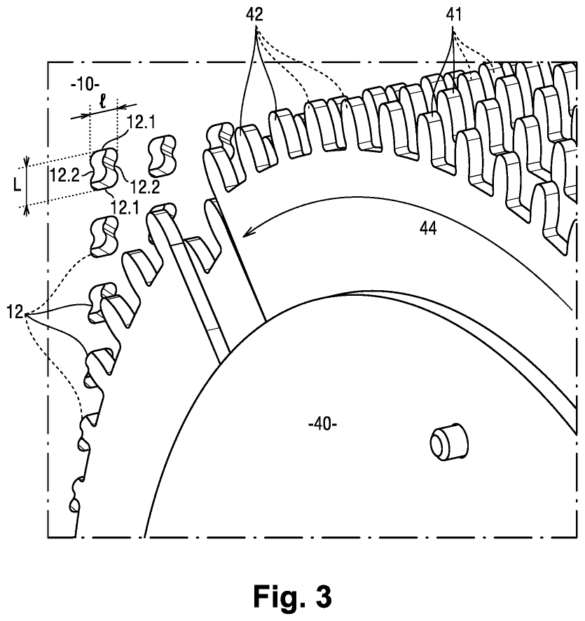

As shown in FIG. 3, the openings 12 have a section substantially in the form of a quadrilateral, the corners of which are rounded and are delimited by two flat first surfaces 12. 1 that each extend in a plane that includes the axis X₁₀, and by two convex second surfaces 12.2 that are symmetrical with respect to a plane perpendicular to the axis X₁₀. Here, the openings 12 have a width 1 substantially equal to 6 millimetres, and a length L substantially equal to 8 millimetres, the width I corresponding to the distance between the two first surfaces and the length L corresponding to the maximum distance between the two first surfaces along the axis X₁₀.

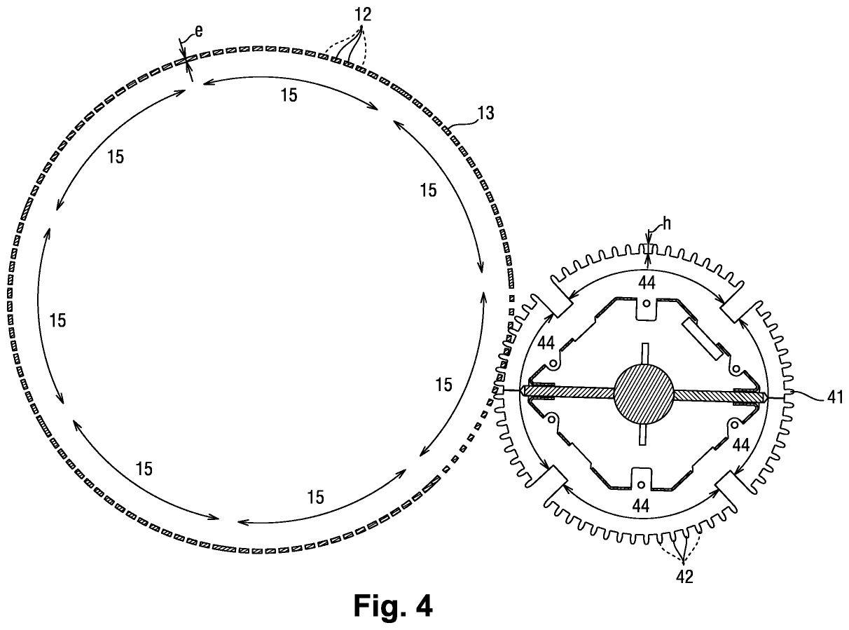

Here, the trommel 10 comprises sixty identical rows 13 of one hundred and twelve openings 12 along the axis X₁₀. The sixty rows 13 are distributed into three sets 14 of twenty rows. The one hundred and twelve openings 12 of each of the sixty rows 13 are distributed symmetrically about the axis X₁₀ into seven angular discharge sectors 15 of sixteen openings 12 (FIG. 4).

A rotary cylindrical brush 20 and a rolling cylinder 30 are mounted inside the trommel 10.

The brush 20 extends along an axis X₂₀ substantially parallel to the longitudinal axis X₁₀ of the trommel 10, in the third quadrant of the trommel 10 when said trommel is observed from its second end portion 10.2. The brush 20 bears against an inner surface of the trommel 10 and is driven in rotation by a second motor (not shown) supported by the frame 2.

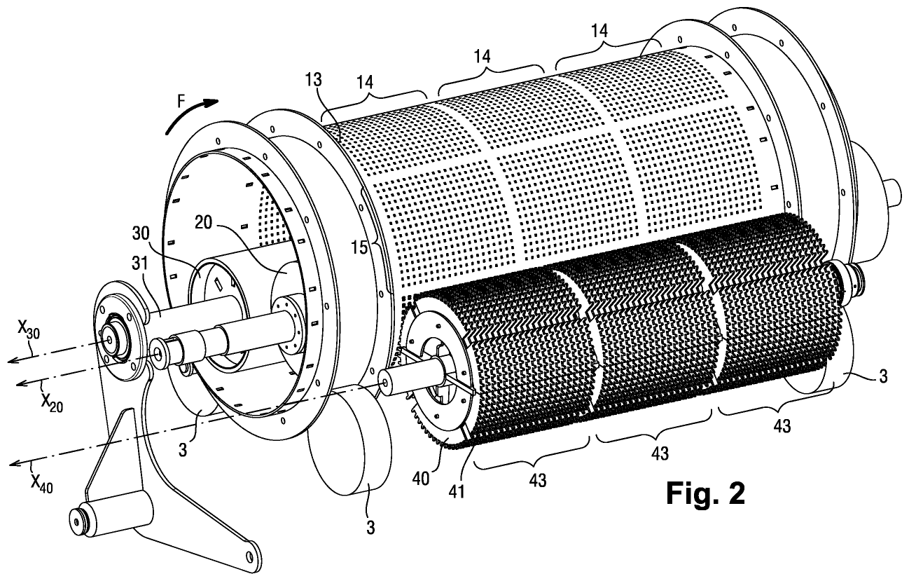

In operation, the brush 20 and the trommel 10 rotate in the same direction, indicated in the figure by an arrow F (FIG. 2), the speed of rotation of the brush 20 being greater than that of the trommel 10. Here, the speed of rotation of the brush 20 is substantially equal to twice that of the trommel 10.

The rolling cylinder 30 is cylindrical in shape and extends along an axis X₃₀ substantially parallel to the longitudinal axis X₁₀ of the trommel 10, in the third quadrant of the trommel 10 when said trommel is observed from its second end portion 10.2. The cylinder 30 is supported by a shaft 31, the ends of which are each mounted so as to rotate freely on a first end 32.1 of an L-shaped arm 32 extending in a plane perpendicular to the axis X₃₀ of the cylinder 30. Each of the arms 32 comprises a second end 32.2 that is secured to a rod of a double-acting actuator (not shown), a body of which is connected to the frame 2, and a third end 32.3 that is arranged between the first end 32.1 and the second end 32.2 and is mounted so as to rotate freely on the frame about an axis X₃₂ substantially parallel to the axis X₃₀ of the cylinder 30. The actuator extends in the same plane as that in which the arm 32 extends, such that said arm 32 forms a lever that allows the actuator to pivot the cylinder 30 about the axis X₃₂ between a first “operating” position in which an outer surface of the cylinder 30 bears against the inner surface of the trommel 10, and a second “cleaning” position in which the outer surface of the cylinder 30 is at a distance from said inner surface of the trommel 10 and is in contact with the brush 20.

In operation, the actuator makes it possible to resiliently hold the rolling cylinder 30 in abutment against the trommel 10 by applying a force of a few kilonewtons to said cylinder 30 via the lever effect afforded by the arms 32. The cylinder 30 is then driven in rotation by the trommel 10 and rolls over the inner surface of said trommel such that, in operation, the speed of rotation of the cylinder 30 is proportional to that of the trommel 10.

In the cleaning position, the actuator makes it possible to resiliently hold the rolling cylinder 30 in abutment against the brush 20, which, when the brush 20 is driven in rotation by the second motor, causes cleaning of the outer surface of said cylinder 30.

A toothed roller 40 is mounted outside the trommel 10, forming means for unclogging the openings 12 of the trommel 10. The roller 40 extends along a longitudinal axis X₄₀ substantially parallel to the longitudinal axis X₁₀ of the trommel 10, and has ends mounted so as to rotate freely about the axis X₄₀. The roller 40 comprises sixty identical rows 41 of sixty four teeth 42. The teeth 42 have a height h greater than the thickness e of the trommel 10 and are arranged to cooperate with the openings 12 in the trommel 10 in the manner of two gearwheels (FIG. 4): the sixty rows 41 of teeth 42 are distributed in three sets 43 of twenty rows 42, and the sixty four teeth 42 of each of the sixty rows 41 are distributed symmetrically about the axis X₄₀ in four angular sectors 44 for the meshing of sixteen teeth 42.

In operation, the unclogging roller 40 is thus driven in rotation by the trommel 10, with the speed of rotation of said roller 40 being proportional to the speed of said trommel 10.

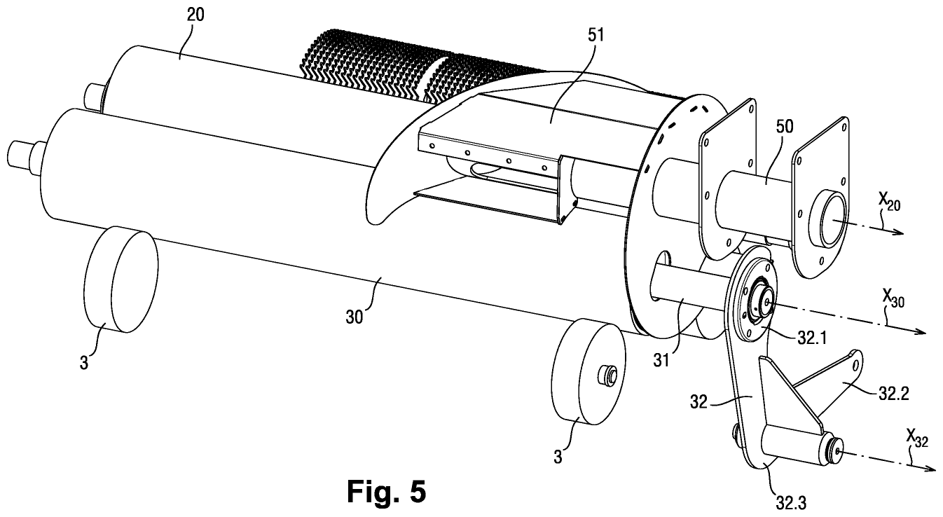

The device 1 also comprises means for introducing a soup of organic matter into the trommel 10, the soup comprising solid particles to be collected (plastic particles, packaging residues, etc.). As shown in FIG. 5, the introduction means comprise a tube 50 extending along an axis substantially parallel to the axis X₁₀, the first quadrant of the trommel 10 when said trommel is observed from its second end portion 10.2. The tube 50 comprises a first end that opens to the outside of the trommel 10 and a second end that opens to the inside of the trommel 10. The first end of the tube 50 is provided with means for connection (not shown) to a source of a soup of organic matter. For example, the connection means comprise a quick-fitting pipe union. For example, the source of a soup of organic matter comprises a pump connected to a tank for a soup of organic matter. The second end of the tube 50 is provided with a deflector 51 that makes it possible to direct the soup towards the rolling cylinder 30.

A hopper 60 for recovering organic matter is placed under the trommel 10 and directs said organic matter towards a container (not shown).

The first motor and the second motor are connected to a control unit provided with variable speed drives for said first motor and said second motor, a memory, a touch display and wireless communication means.

The operation of the device 1 will now be described in detail.

While a soup of organic matter is introduced into the trommel 10 via the tube 50 and directed towards the rolling cylinder 30 via the deflector 51, the control unit commands the start-up of the first and second motors in order to drive the trommel 10 and the brush 20 respectively in rotation about their respective axes X₁₀, X₂₀. The trommel 10 then drives the unclogging roller 40 and the rolling cylinder 30 in rotation via the contact pressure which is applied and adjusted by the actuators.

The solid particles contained in the soup are then compressed between the rolling cylinder 30 and the inner surface of the trommel 10, then are caught by the brush 20 and brought into the zone of contact between the brush 20 and the inner surface of the trommel 10, in which zone the solid particles are subjected to intense brushing, which results in the removal of an amount of organic matter adhering to the solid particles. Once the solid particles have left the contact zone, they are ejected by the brush 20 towards an upper region and strike the inner surface of the trommel 10 before being caught again by the brush 20 which brings them into the contact zone in order to be again subjected to intense brushing therein. With each brushing, the solid particles lose an additional amount of organic matter adhering to their surface.

The dimensions of the openings 12 in the trommel 10 are selected to retain the solid particles inside the trommel while allowing the organic matter to pass through. The passage of the organic matter is facilitated by the centrifugal effect of the rotation of the trommel 10, such that said organic matter ends up in the housing while the solid particles are retained inside the trommel 10.

The agglomerations of organic matter blocking the openings 12 of the trommel 10 are discharged by the teeth 42 of the unclogging roller 40 and drop into the trommel 10, where the brush 20 and the rolling cylinder 30 break them up and discharge them through the openings 12.

The solid particles can be discharged from the trommel 10 for example by a blowing device (not shown) mounted inside the first end portion 10.1 of the trommel 10 in order to generate an air flow comprising a component parallel to the axis X₁₀, so as to blow the solid particles on which there is no, or very little, remaining organic matter out of the trommel 10 via the first end portion 10.2 of said trommel 10.

Of course, the invention is not limited to the embodiment described, but covers any variant falling within the scope of the invention as defined by the claims.

Although the unclogging means here comprise a toothed wheel 40, the invention applies equally to other means for unclogging the trommel 10 while it is rotating, for instance high-pressure injection of water, of air, or of shot which strikes the trommel 10.

Although the rolling cylinder 30 is held resiliently here in abutment against the trommel 10 via a double-acting actuator, it may also be held in abutment by any other resilient means such as a single-acting actuator and/or a tension spring, a compression spring, etc. The position for cleaning the rolling cylinder 30 by the brush 20 may then be optional.

The dimensions of the openings 12 in the trommel 10 may be different from those described.

The number of openings and their arrangement (number of rows, sets, angular sectors, etc.) may be different from those described.

1. A device for collecting solid particles contained in a soup of organic matter, the device comprising:
a trommel (10) provided with openings (12) to form a screen that retains solid particles and allows organic matter to pass through;
a rotary brush (20) mounted in the trommel for brushing an inner surface of said trommel;
motorised means arranged to drive the trommel and the brush in rotation;
a rolling cylinder (30) mounted in the trommel and arranged so that an outer surface of the rolling cylinder bears against the inner surface of the trommel so as to force the organic matter to pass through the openings in the trommel.

2. The device (1) according to claim 1, wherein the brush (20) extends along an axis (X₂₀) parallel to a longitudinal axis (X₁₀) of the trommel (10).

3. The device (1) according to claim 1, wherein the rolling cylinder (30) extends along an axis (X₃₀) parallel to a longitudinal axis (X₁₀) of the trommel (10).

4. The device (1) according to claim 1, comprising unclogging means (40) arranged to at least partially unblock the openings (12) in the trommel (10) during the rotation of said trommel.

5. The device (1) according to claim 4, wherein the unclogging means comprise an unclogging roller (40) provided with teeth (42) which are intended to engage at least partially in the openings (12) of the trommel (10) during the rotation of said trommel.

6. The device (1) according to claim 5, wherein the teeth (42) of the unclogging roller (40) have a height (h) greater than a thickness (e) of the trommel (10).

7. The device (1) according to claim 5 or 6, wherein the unclogging roller (40) is mounted outside the trommel (10).

8. The device (1) according to claim 1, comprising means for introducing the soup of organic matter into the trommel (10), the introduction means comprising a tube (50) having a first end that opens to the outside of the trommel (10) and a second end that opens to the inside of the trommel.

9. The device (1) according to claim 8, wherein the first end of the tube (50) is provided with means for connection to a source of a soup of organic matter.

10. The device (1) according to claim 8, wherein the second end of the tube (50) is provided with a deflector (51) arranged to direct the soup of organic matter towards the rolling cylinder (30).

11. A method for collecting solid particles contained in an soup of organic matter, comprising introducing the soup of organic matter into the trommel (10) of the device (1) according to claim 1.

12. A packaging treatment plant, comprising a device for collecting the organic matter adhering to the packaging in the form of a soup, and the device according to claim 1 for collecting the solid particles contained in the soup.

13. An use of the device (1) according to claim 1 for collecting solid particles contained in an soup of organic matter.
